(19) United States
(12) Patent Application Publication
(10) Pub. No.: US 2014/0289252 A1
(43) Pub. Date: Sep. 25, 2014

(54) METHOD AND SYSTEM FOR MANAGING WEBPAGE LINKS IN A BROWSER

(71) Applicant: TENCENT TECHNOLOGY (SHENZHEN) COMPANY LIMITED, Shenzhen (CN)

(72) Inventor: XIAODAN LIN, Shenzhen (CN)

(73) Assignee: TENCENT TECHNOLOGY (SHENZHEN) COMPANY LIMITED, Shenzhen (CN)

(21) Appl. No.: 14/242,896

(22) Filed: Apr. 2, 2014

Related U.S. Application Data
(63) Continuation of application No. PCT/CN2013/087935, filed on Nov. 27, 2013.

(30) Foreign Application Priority Data
Mar. 22, 2013 (CN) 2013100964801

(51) Int. Cl. G06F 17/30

(52) U.S. Cl. CPC G06F 17/30601
USPC 707/738

(57) ABSTRACT

A method for managing webpage links in a browser is provided. The method includes receiving an instruction signal from a user of the browser for merging at least two specified webpage links of the browser. The method also includes automatically generating a new folder using multi-level path information of the at least two specified webpage links based on the instruction signal. Further, the method includes storing the specified webpage links in the new folder and displaying the new folder with the specified webpage links to the user.

### CROSS-REFERENCES TO RELATED APPLICATIONS

This application is a continuation application of PCT Patent Application No. PCT/CN2013/087935, filed on Nov. 27, 2013, which claims priority of Chinese Patent Application No. 201310096480.1, filed on Mar. 22, 2013, the entire contents of all of which are incorporated by reference herein.

### FIELD OF THE INVENTION

The present invention generally relates to computer technologies and, more particularly, to a method and system for managing webpage links in a browser.

### BACKGROUND

With the rapid development of Internet technologies, browsers become necessary tools for using the network. Users can freely roam the mobile Internet world and obtain large amounts of information through the browsers. Nowadays, in order to enable users to obtain frequently-used network links, many browsers support features such as favorites, bookmarks, or quick links to manage webpage links. For example, a webpage link can be bookmarked through favorites. When a user needs the webpage link again, the user can directly click on a corresponding webpage link in the favorites. The user can also obtain corresponding webpage contents by quickly clicking on a quick link of a start page of the browser.

However, existing technologies for managing the webpage links are only restricted to simple centralized management. During user operation, there are a lot of inconveniences. For example, when merging webpage links in bookmarks of a browser, a user needs to manually create a new folder and then merge the webpage links into the newly created folder. In the process of merging and storing the quick links of the browser, the webpage links are merged into a default folder, and a user cannot create a new folder. Therefore, in existing technologies, operation steps for merging and storing webpage link addresses are complex and time-consuming.

The disclosed method and system are directed to solve one or more problems set forth above and other problems.

### BRIEF SUMMARY OF THE DISCLOSURE

One aspect of the present disclosure includes a method for managing webpage links in a browser. The method includes receiving an instruction signal from a user of the browser for merging at least two specified webpage links of the browser. The method also includes automatically generating a new folder using multi-level path information of the at least two specified webpage links based on the instruction signal. Further, the method includes storing the specified webpage links in the new folder and displaying the new folder with the specified webpage links to the user.

Another aspect of the present disclosure includes a system for managing webpage links in a browser. The system includes a receiving unit configured to receive an instruction signal from a user of the browser for merging at least two specified webpage links of the browser. The system also includes a generating unit configured to automatically generate a new folder using multi-level path information of the at least two specified webpage links. Further, the system includes a storage unit configured to store the specified webpage links in the new folder.

Other aspects of the present disclosure can be understood by those skilled in the art in light of the description, the claims, and the drawings of the present disclosure.

### BRIEF DESCRIPTION OF THE DRAWINGS

In order to more clearly illustrate technical solutions of the present invention, the figures which are needed to be used in the description of the present invention or the existing technology are briefly described in the following. Obviously, the figures in the following description are only some embodiments of the present invention, and it is easily for those skilled in the art to obtain other figures based on the following figures without creative work.

FIG. 1 illustrates a flow chart of an exemplary process for managing webpage links in a browser consistent with the disclosed embodiments;

FIG. 2 illustrates a flow chart of another exemplary process for managing webpage links in a browser consistent with the disclosed embodiments;

FIG. 3 illustrates a flow chart of an exemplary process for naming a folder consistent with the disclosed embodiments;

FIG. 4a-4c illustrate a schematic diagram of merging and storing webpage links consistent with the disclosed embodiments;

FIG. 5a-5b illustrate another schematic diagram of merging and storing webpage links consistent with the disclosed embodiments;

FIG. 6 illustrates a structure diagram of an exemplary webpage link management system consistent with the disclosed embodiments;

FIG. 7 illustrates a structure diagram of another exemplary webpage link management system consistent with the disclosed embodiments; and

FIG. 8 shows a block diagram of an exemplary computing system according to the disclosed embodiments.

### DETAILED DESCRIPTION

Reference will now be made in detail to exemplary embodiments of the invention, which are illustrated in the accompanying drawings.

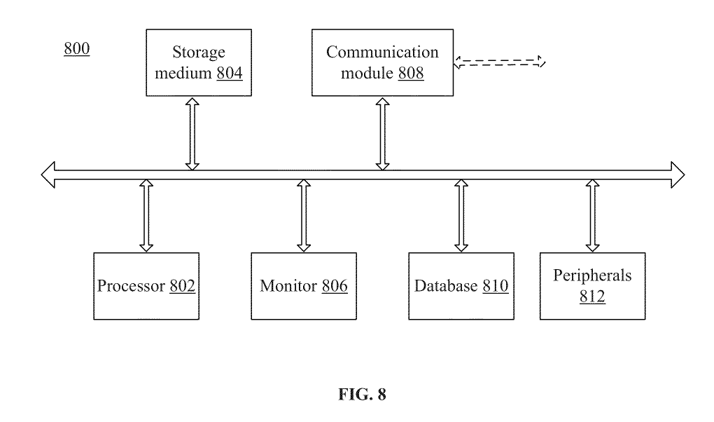

A webpage link management system may be implemented on any appropriate computing platform. After receiving an instruction signal from a user of the browser for merging at least two specified webpage links of the browser, the webpage link management system automatically generates a new folder and stores the specified webpage links in the new folder. FIG. 8 shows a block diagram of an exemplary computer system 800 capable of implementing the webpage link management system.

As shown in FIG. 8, computer system 800 may include a processor 802, a storage medium 804, a monitor 806, a communication module 808, a database 810, and peripherals 812. Certain devices may be omitted and other devices may be included.

Processor 802 may include any appropriate processor or processors. Further, processor 802 can include multiple cores for multi-thread or parallel processing. Storage medium 504 may include memory modules, such as ROM, RAM, flash memory modules, and erasable and rewritable memory, and mass storages, such as CD-ROM, U-disk, and hard disk, etc. Storage medium 804 may store computer programs for implementing various processes, when executed by processor 802.

Further, peripherals 812 may include I/O devices such as keyboard and mouse, and communication module 808 may include network devices for establishing connections through the communication network. Database 810 may include one or more databases for storing certain data and for performing certain operations on the stored data, such as database searching.

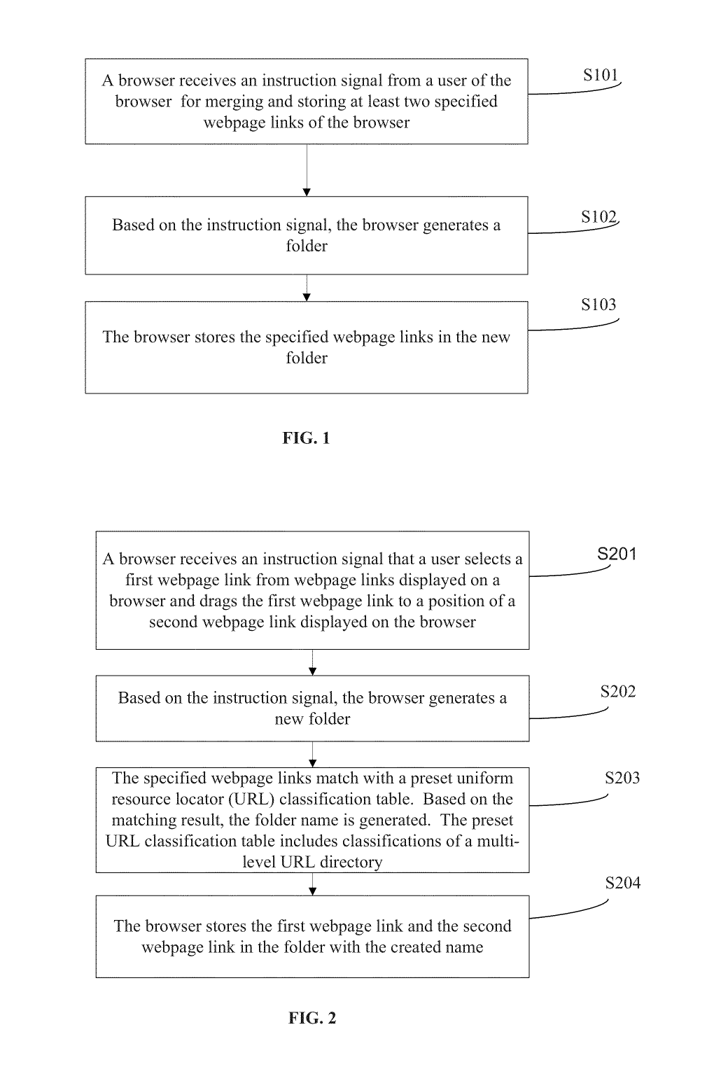

In operation, computer system 800 may run a web browser and perform certain service for managing webpage links. FIG. 1 illustrates a flow chart of an exemplary process for managing webpage links in a browser consistent with the disclosed embodiments. As shown in FIG. 1, the webpage link management process may include the following steps.

S101: a browser receives an instruction signal from a user of the browser for merging and storing at least two specified webpage links of the browser.

The webpage link may include a webpage link in a bookmark of the browser, a webpage link in browsing history, a webpage link in favorites, and/or a webpage link corresponding to a quick link of the browser.

The webpage link to be merged and stored can be pre-selected and inputted by a user, or can be determined by the user when the user inputs a merging instruction signal.

S102: based on the instruction signal, the browser generates a folder.

Based on the instruction signal, the browser may automatically generate a new folder. That is, the folder does not need to be manually created by the user. The folder is used to store the webpage links to be merged and stored. For example, when merging webpage links of the homepage of a browser, the folder is located at the homepage of the browser. When merging webpage links in favorites, the folder is located at the favorites.

S103: the browser stores the specified webpage links in the new folder.

After S103 is performed, when receiving a signal that a user holds and drags any other webpage link address displayed on the browser to the position of the folder, the browser stores the webpage page link address that is held and dragged by the user in the folder. Thus, after merging and storing the specified webpage links, the browser may continuously store other webpage link addresses in the same folder, facilitating merging and storing the same kind of webpage link addresses.

Thus, when a browser receives an instruction signal inputted by a user for merging and storing at least two specified webpage links of the browser, based on the instruction signal, the browser generates a folder and stores the specified webpage links in the folder. That is, based on the merging instruction, the browser automatically generates the folder and quickly merges the webpage links, making the process simple and convenient.

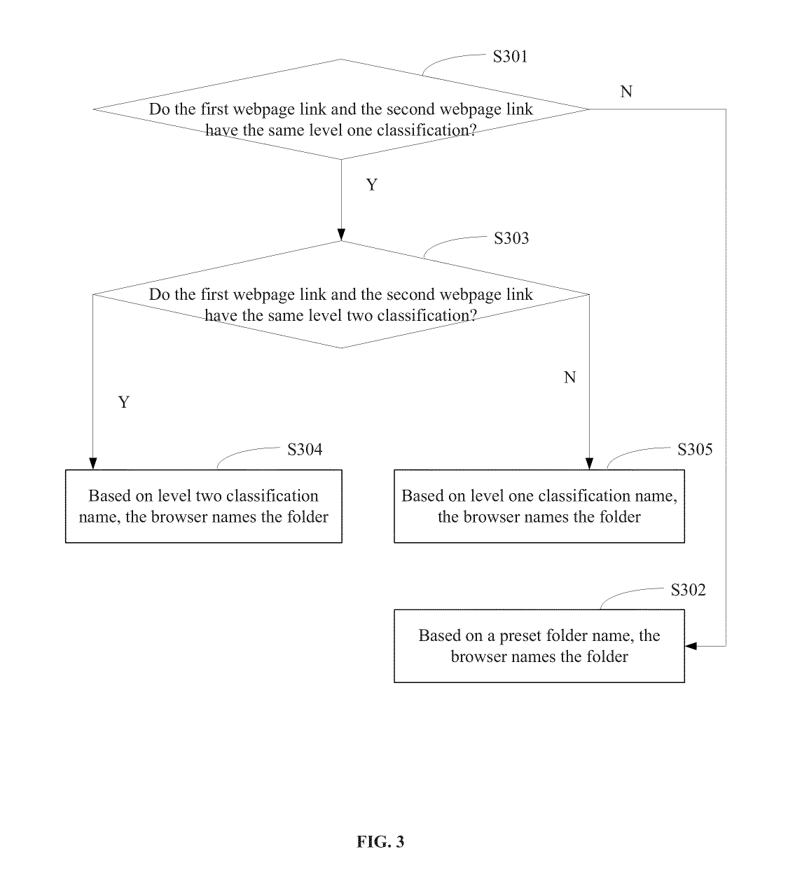

FIG. 2 illustrates a flow chart of another exemplary process for managing webpage links in a browser consistent with the disclosed embodiments. As shown in FIG. 2, the webpage link management process may include the following steps.

S201: a browser receives an instruction signal that a user selects a first webpage link from webpage links displayed on a browser and drags the first webpage link to a position of a second webpage link displayed on the browser. The first webpage link includes at least one webpage link. The first webpage link and the second webpage link may also be referred as specified webpage links. Further, the first webpage link may include a single webpage link or multiple webpage links.

Specifically, the position of the second webpage link that the first webpage link is dragged to may be an overlap position of the second webpage link that the first webpage link is dragged to. The position of the second webpage link that the first webpage link is dragged to may be a partial overlap position of the second webpage link that the first webpage link is dragged to. For example, the partial overlap position may be a two-third overlap position or a one-third overlap position.

S202: based on the instruction signal, the browser generates a new folder.

Based on the instruction signal, the browser may automatically generate a new folder using multi-level path information of the at least two specified webpage links. That is, the folder does not need to be manually created by the user. The folder is used to store the webpage links to be merged and stored. For example, when merging webpage links of bookmarks of a browser, the folder is located at the bookmarks of the browser. When merging webpage links in the bookmarks of the browser, the new folder is located at the bookmarks of the browser.

S203: the specified webpage links match with a preset Uniform Resource Locator (URL) classification table. Based on the matching result, the folder name is generated. The preset URL classification table includes classifications of a multi-level URL directory.

Based on the matching result, the folder name is automatically generated, eliminating the inconvenience of manually renaming the folder. In addition, the browser names the folder after matching the specified webpage links with the URL classification table. Therefore, the users can easily find the related webpage links based on the folder name. Of course, the users may also manually modify the folder name based on users' needs.

Based on the classifications of a multi-level URL directory included in the URL classification table, the browser searches the classifications of every directory level of the webpage link. For ease of understanding, an example of the URL classification table is given in the following table. As shown in Table 1, the URL classification table includes level one classification and level two classification of URL addresses, which are not limited to the classification of the table.

TABLE 1
URL Classification Table

| Level One | Level Two | Memo |
|---|---|---|
| Search | — | baidu.com, soso.com, google.com, |
| | | yicha.com, easou.com, bing.com, etc. |
| Navigation | — | hao123.com, 2345.com, 265.com, etc. |
| Portal | — | 3g.qq.com, 3g.cn, Sina.com, Sohu.com, |
| | | Phoenixtv.com, 163.com, etc. |
| Images | — | URLs containing pic, img, and image tag; |
| | | _{——}moko.cc, tuchong.com, huaban.com, |
| | | etc. |
| Information | News | URLs containing news tag |
| | Sports | URLs containing sport, NBA, basket tag; |
| | | nba.com, zhibo8.cc, spbo.com, etc. |
| | Technology | URLs containing tech tag; 36kr.com, |
| | | ifanr.com, techweb.com, alibuybuy.com, |
| | | etc. |
| | Entertainment | URLs containing ent tag |
| | Estates | URLs containing focus, house tag; |
| | | soufun.com, sofang.com, etc. |
| | Finance | URLs containing finance tag; |
| | | dfzq.com.cn, cnstock.com, 10jqka.com.cn, |
| | | zhihuangjin.com, etc. |
| | Military | URLs containing military, mil, war tag; |
| | | _{——}tiexue.net, junshi.xilu.com, etc. |
| | Automobile | URLs containing auto tag; |
| | | _autohome.com.cn, pcauto.com.cn, etc. |
| | Lady | URLs containing lady tag; rayli.com.cn, |
| | | Yoka.com, etc. |
| | Education | URLs containing edu tag; neworiental.org, |
| | | university websites |
| | Constellation | URLs containing astro tag; |
| | | _nownow.qzone.qq.com |
| Life | Classified-ad | 58.com, ganji.com, baixing.com, etc. |
| | Weather | weather.com, wunderground.com, etc. |
| | Transportation | zuoche.com |
| | Job | 51job.com, zhaopin.com, dajie.com, etc. |
| | Travel/Hotel | elong.com, qunar.com, ctrip.com, etc. |
| Social | Microblog | Sina, Tencent, Netease, Sohu, Phoenixtv, |
| | | etc. |
| Media | Social | Renren.com, kaixin001.com, 51.com, etc. |
| | Network | |
| | Service (SNS) | |
| | Blogs | Qzone.com |
| | Forum | Tianya.cn, MOP.com, etc. |
| | Online dating | Baihe.com, zhenai.com, jiayuan.com, etc. |
| Shopping | — | taobao.com, paipai.com, jd.com, |
| | | vancl.com, tmall.com, coo8.com, |
| | | groupon.com, livingsocial.com, etc. |
| Game | — | 4399.com, 2366.com, 155.cn, etc. |
| Software | — | gfan.com, weiphone.com, etc. |
| Novel | — | Shuqi.com, qidian.com, |
| | | novel.wap.soso.com, book.easou.com, etc. |
| Music | — | kuwo.cn, sogou.com, 1ting.com, etc. |
| Video | — | youku.com, todou.com, 56.com, etc. |
| Lottery | — | lottery.gov.cn, 500wan.com, etc. |
| Funny | — | qiushibaike.com, lengxiaohua.cn, etc. |
| Other | — | — |

In certain embodiments, S203 and S202 can be concurrently performed, or S203 can be performed after S202 is done. The order of performing can be set according to computer program's needs, which is not limited to the disclosure herein.

Further, when the first webpage link includes one webpage link, S203 can be performed by using the method as noted below. FIG. 3 illustrates a flow chart of an exemplary process for naming a folder consistent with the disclosed embodiments. The process includes the steps also as noted below.

S301: the first webpage link and the second webpage link match with a preset URL classification table to determine whether the first webpage link and the second webpage link have the same level one classification. If the first webpage link and the second webpage link have the same level one classification, S303 is performed. If the first webpage link and the second webpage link do not have the same level one classification, S302 is implemented.

S302: based on a preset folder name, the browser names the folder.

S303: the browser determines whether the first webpage link and the second webpage link have the same level two classification. If the first webpage link and the second webpage link have the same level two classification, S304 is performed; if the first webpage link and the second webpage link do not have the same level two classification, S305 is performed.

S304: based on level two classification name, the browser names the folder.

S305: based on level one classification name, the browser names the folder.

When the first webpage link includes one webpage link, a bowser needs to merge the two webpage links. At this time, the level one classification and the level two classification of the first webpage link and the level one classification and the level two classification of the second webpage link match with the preset URL classification table. Thus, based on the level one classification and the level two classification of the webpage link, the browser classifies the webpage links, accurately naming the folder.

When the first webpage link includes two or more webpage links, S203 includes the following steps.

The top N levels of classifications of the first webpage link and the second webpage link match with the preset URL classification table, where N is a natural number.

If there is no same classification among the top N levels of classifications of the first webpage link and the second webpage link, based on the preset folder name, the browser names the folder.

If there is the same classification among the top N levels of classifications of the first webpage link and the second webpage link, based on the highest number of same classification from the first webpage link and the second webpage link, the browser names the folder.

Further, the browser may match the level one directory and the level two directory of the multiple webpage links with the preset URL classification table. Based on the matching result, the browser names the folder. For example, if the highest number of same classification from the first webpage link and the second webpage link is sports (level two directory of 3 webpage links are sports), the folder is named “sports”.

S204: the browser stores the first webpage link and the second webpage link in the folder with the created name.

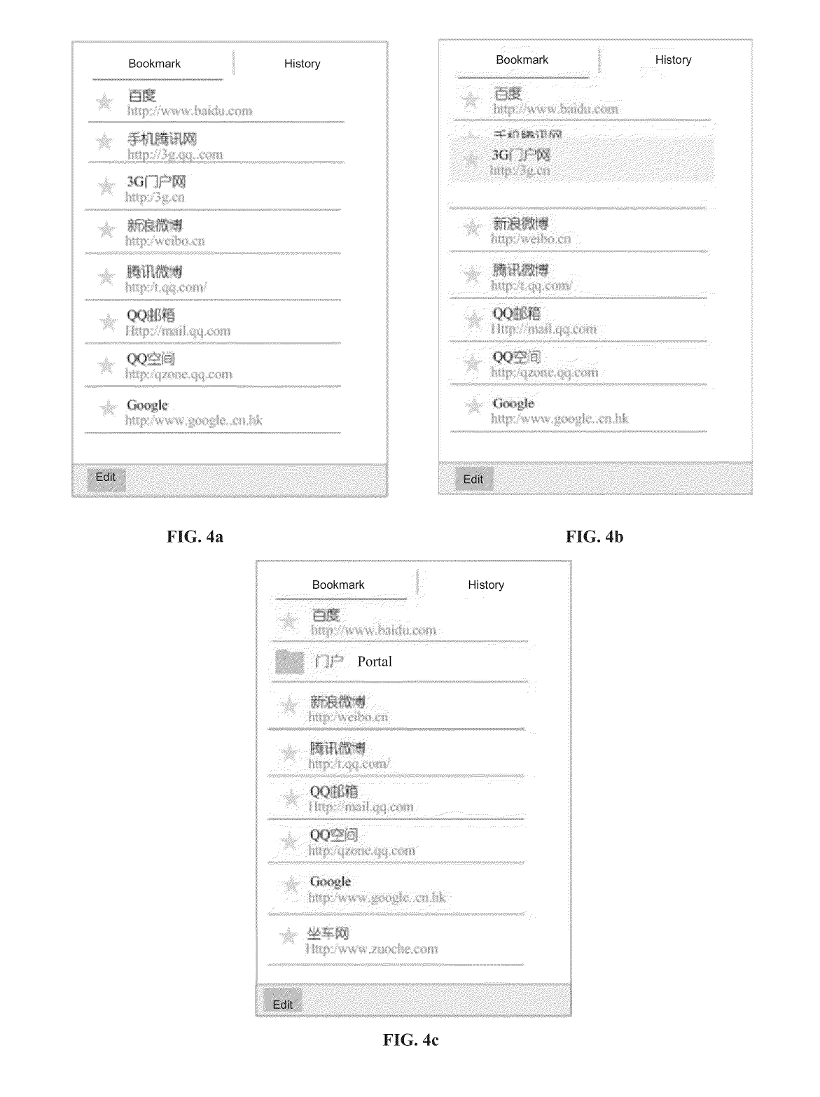

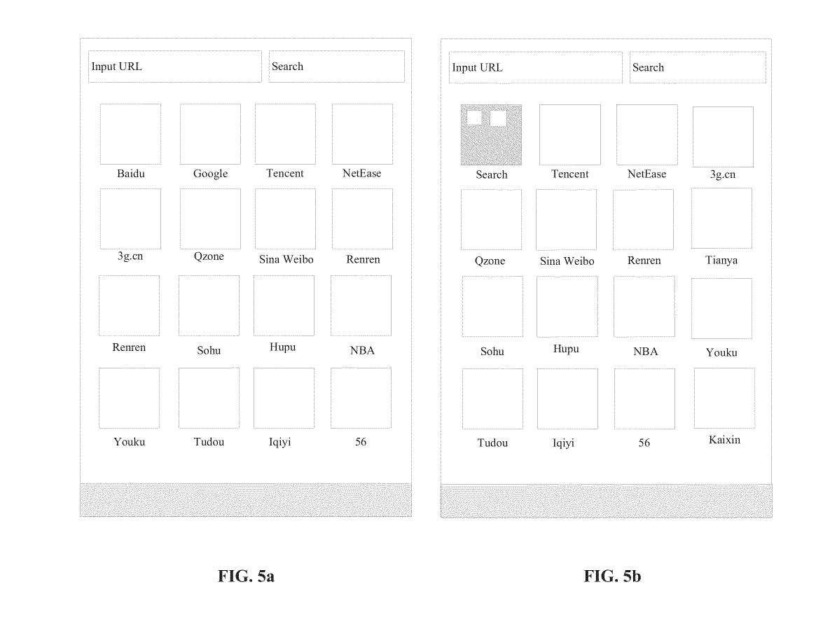

For ease of understanding, the present disclosure is described by an example. FIG. 4a-4c illustrate a schematic diagram of merging and storing webpage links consistent with the disclosed embodiments. As shown in FIG. 4a, bookmarks of a browser include a webpage link corresponding to baidu.com, a webpage link corresponding to 3g.qq.com, a webpage link corresponding to 3g.cn, a webpage link corresponding to weibo.cn, a webpage link corresponding to t.qq.com, a webpage link corresponding to mail.qq.com, a webpage link corresponding to qzone.qq.com, etc. As shown in FIG. 4b, when merging the webpage link corresponding to 3g.qq.com and the webpage link corresponding to 3g.cn, a user may hold the webpage link corresponding to 3g.cn and drag the webpage link corresponding to 3g.cn to the position of the webpage link corresponding to 3g.qq.com. As shown in FIG. 4c, a folder is automatically generated. The webpage link corresponding to 3g.qq.com and the webpage link corresponding to 3g.cn match with the URL classification table (i.e. Table 1). A matching result shows the two level one classifications are the same (i.e. portal website). Therefore, the folder is named “portal”. Then, the webpage link corresponding to 3g.cn and the webpage link corresponding to 3g.qq.com are added to the folder named “portal”.

FIGS. 5a and 5b illustrate a schematic diagram of merging and storing webpage links consistent with the disclosed embodiments. As shown in FIG. 5a, the homepage of a browser provides a quick link corresponding to baidu.com, a quick link corresponding to google.com, a quick link corresponding to t.qq.com, a quick link corresponding to 3g.163.com, etc. When merging the quick link corresponding to baidu.com and the quick link corresponding to google.com, a user may hold the quick link corresponding to baidu.com and drag the quick link corresponding to baidu.com to the position of the quick link corresponding to google.com. As shown in FIG. 5b, a folder is automatically generated. The webpage link corresponding to baidu.com and the webpage link corresponding to google.com match with a URL classification table (i.e. Table 1). A matching result shows the two level one classifications are the same (i.e. search website). Therefore, the folder is named “search”. Then, the webpage link corresponding to baidu.com and the webpage link corresponding to google.com are added to the folder named “search”.

As used herein, a browser receives an instruction signal that a user selects a first webpage link from webpage links displayed on a browser and drags the first webpage link to a position of a second webpage link displayed on the browser. Based on the instruction signal, the browser generates a folder and stores the first webpage link and the second webpage link in the folder. Thus, the webpage links of the browser are merged by using a dragging method.

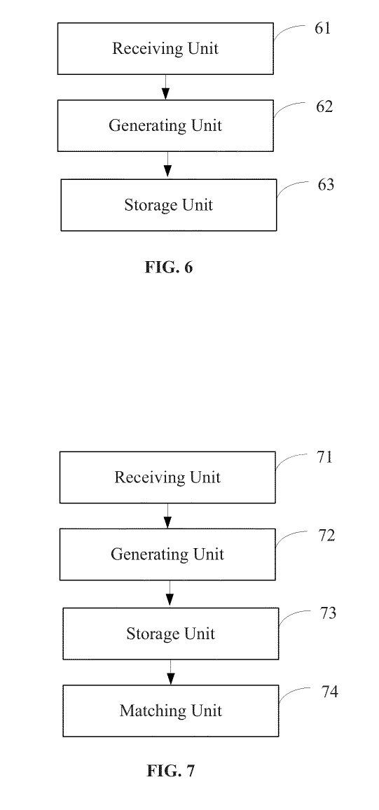

FIG. 6 illustrates a structure diagram of an exemplary webpage link management system consistent with the disclosed embodiments. The webpage link management system can be a hardware unit, a computer software unit, or a combination thereof built into a terminal apparatus. In order to clearly illustrate this interchangeability between hardware and software, functions of a variety of schematic components, boxes, modules, and circuits are generally described. As shown in FIG. 6, the system includes a receiving unit 61, a generating unit 62, and a storage unit 63.

The receiving unit 61 is configured to receive an instruction signal from a user of the browser for merging at least two specified webpage links of the browse. The generating unit 62 is configured to automatically generate a new folder using multi-level path information of the at least two specified webpage links. Further, the storage unit 63 is configured to store the specified webpage links in the new folder.

Optionally, the receiving unit 61 is further configured to receive a signal that a user holds and drags any other webpage link address displayed on the browser to the position of the folder. The storage unit 63 is further configured to store any other webpage link in the folder.

FIG. 7 illustrates a structure diagram of another exemplary webpage link management system consistent with the disclosed embodiments. As shown in FIG. 7, the system includes a receiving unit 71, a generating unit 72, a storage unit 73 and a matching unit 74.

The receiving unit 71 is configured to receive an instruction signal for merging and storing at least two specified webpage links of a browser. The generating unit 72 is configured to generate a folder based on the instruction signal. Further, the storage unit 73 is configured to store the specified webpage links in the folder.

The matching unit 74 is configured to match the specified webpage links with a preset uniform resource locator (URL) classification table and generate the folder name based on the matching result, where the preset URL classification table includes classifications of a multi-level URL directory.

Optionally, the receiving unit 71 is further configured to receive an instruction signal that a user selects a first webpage link from webpage links displayed on a browser and drags the first webpage link to a position of a second webpage link displayed on the browser, where the first webpage link includes at least one webpage link, and the specified webpage links include the first webpage link and the second webpage link. The storage unit 73 is further configured to store the first webpage link and the second webpage link in the folder.

Optionally, when the first webpage link includes one webpage link, the matching unit 74 is further configured to match the first webpage link and the second webpage link with a preset URL classification table to determine whether the first webpage link and the second webpage link have the same level one classification. When the first webpage link and the second webpage link have the same level one classification, the matching unit 74 determines whether the first webpage link and the second webpage link have the same level two classification. If the first webpage link and the second webpage link have the same level two classification, based on level two classification name, the matching unit 74 names the folder. If the first webpage link and the second webpage link do not have the same level two classification, based on level one classification name, the matching unit 74 names the folder.

Optionally, the matching unit 74 is configured to, when the first webpage link and the second webpage link do not have the same level one classification, name the folder based on a preset folder name.

Optionally, when the first webpage link includes two or more webpage links, the matching unit 74 is configured to match the top N levels of classifications of the first webpage link and the second webpage link with the preset URL classification table, where N is a natural number. If there is the same classification among the top N levels of classifications of the first webpage link and the second webpage link, based on the highest number of same classification from the first webpage link and the second webpage link, the matching unit 74 names the folder.

Optionally, the matching unit 74 is configured to, when there is no same classification among the top N levels of classifications of the first webpage link and the second webpage link, name the folder based on the preset folder name.

Optionally, the receiving unit 71 is further configured to receive a signal that a user holds and drags any other webpage link address displayed on the browser to the position of the folder. The storage unit 73 is further configured to store any other webpage link in the folder.

Optionally, the webpage link may include a webpage link in a bookmark of the browser, a webpage link in browsing history, a webpage link in favorites, and/or a webpage link corresponding to a quick link of the browser.

Those skilled in the art should understand that all or part of the steps in the above method may be executed by relevant hardware instructed by a program, and the program may be stored in a computer-readable storage medium such as a read only memory, a magnetic disk, a Compact Disc (CD), and so on.

The embodiments disclosed herein are exemplary only and not limiting the scope of this disclosure. Without departing from the spirit and scope of this invention, other modifications, equivalents, or improvements to the disclosed embodiments are obvious to those skilled in the art and are intended to be encompassed within the scope of the present disclosure.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

By using the disclosed method and system for managing webpage links in a browser, when a browser receives an instruction signal inputted by a user for merging and storing at least two specified webpage links of the browser, based on the instruction signal, the browser generates a folder and stores the specified webpage links in the folder. That is, based on the merging instruction, the browser automatically generates the folder and quickly merges the webpage links, making the process simple and convenient.

What is claimed is:

1. A method for managing webpage links in a browser, comprising:
receiving an instruction signal from a user of the browser for merging at least two specified webpage links of the browser;
based on the instruction signal, automatically generating a new folder using multi-level path information of the at least two specified webpage links;
storing the specified webpage links in the new folder; and
displaying the new folder with the specified webpage links to the user.

2. The method according to claim 1, before storing the specified webpage links in the new folder, further comprising:
matching the specified webpage links with a preset uniform resource locator (URL) classification table, where the preset URL classification table includes classifications of a multi-level URL directory; and
based on a matching result, generating the folder name.

3. The method according to claim 1, wherein receiving an instruction signal from a user of the browser for merging at least two specified webpage links of the browser further comprises:
receiving an instruction signal that a user selects a first webpage link from webpage links displayed on the browser and drags the first webpage link to a position of a second webpage link displayed on the browser, wherein the first webpage link includes at least one webpage link; and the specified webpage links include the first webpage link and the second webpage link.

4. The method according to claim 1, wherein storing the specified webpage links in the folder further comprises:
storing the first webpage link and the second webpage link in the folder.

5. The method according to claim 2, when the first webpage link includes one webpage link, wherein matching the specified webpage links with the preset URL classification table and generating a folder name based on a matching result further comprises:
matching the first webpage link and the second webpage link with the preset URL classification table to determine whether the first webpage link and the second webpage link have the same level one classification;
when the first webpage link and the second webpage link have the same level one classification, determining whether the first webpage link and the second webpage link have the same level two classification;
when the first webpage link and the second webpage link have the same level two classification, based on level two classification name, naming the folder; and
when the first webpage link and the second webpage link do not have the same level two classification, based on level one classification name, naming the folder.

6. The method according to claim 5, further comprising:
when the first webpage link and the second webpage link do not have the same level one classification, based on a preset folder name, naming the folder.

7. The method according to claim 3, when the first webpage link includes two or more webpage links, wherein matching the specified webpage links with the preset URL classification table and generating a folder name based on a matching result further comprises:
matching top N levels of classifications of the first webpage link and the second webpage link with the preset URL classification table, wherein N is a natural number; and
when there is the same classification among the top N levels of classifications of the first webpage link and the second webpage link, based on the highest number of same classification from the first webpage link and the second webpage link, naming the folder.

8. The method according to claim 7, further comprising:
when there is no same classification among the top N levels of classifications of the first webpage link and the second webpage link, based on the preset folder name, naming the folder.

9. The method according to claim 1, after storing the specified webpage links in the folder, further comprising:
receiving a signal that a user holds and drags any other webpage link address displayed on the browser to the position of the folder; and
storing the webpage link address that is held and dragged by the user in the folder.

10. The method according to claim 1, wherein:
the webpage link is one of a webpage link in a bookmark of the browser, a webpage link in browsing history, a webpage link in favorites, and a webpage link corresponding to a quick link of the browser.

11. A system for managing webpage links in a browser, comprising:
a receiving unit configured to receive an instruction signal from a user of the browser for merging at least two specified webpage links of the browser;
a generating unit configured to automatically generate a new folder using multi-level path information of the at least two specified webpage links; and
a storage unit configured to store the specified webpage links in the new folder.

12. The system according to claim 11, further comprising:
a matching unit configured to match the specified webpage links with a preset URL classification table and generate the folder name based on a matching result, where the preset URL classification table includes classifications of a multi-level URL directory.

13. The system according to claim 12, further comprising:
the receiving unit further configured to receive an instruction signal that a user selects a first webpage link from webpage links displayed on the browser and drags the first webpage link to a position of a second webpage link displayed on the browser, wherein:
the first webpage link includes at least one webpage link, and the specified webpage links include the first webpage link and the second webpage link.

14. The system according to claim 13, wherein the storage unit is further configured to:
store the first webpage link and the second webpage link in the folder.

15. The system according to claim 14, when the first webpage link includes one webpage link, wherein the matching unit is further configured to:
match the first webpage link and the second webpage link with a preset URL classification table to determine whether the first webpage link and the second webpage link have the same level one classification;
when the first webpage link and the second webpage link have the same level one classification, determine whether the first webpage link and the second webpage link have the same level two classification;
when the first webpage link and the second webpage link have the same level two classification, based on level two classification name, name the folder; and
when the first webpage link and the second webpage link do not have the same level two classification, based on level one classification name, name the folder.

16. The system according to claim 15, wherein the matching unit is further configured to:
when the first webpage link and the second webpage link do not have the same level one classification, based on a preset folder name, name the folder.

17. The system according to claim 13, when the first webpage link comprises two or more webpage links, wherein the matching unit is further configured to:
match the top N levels of classifications of the first webpage link and the second webpage link with the preset URL classification table, wherein N is a natural number; and
when there is the same classification among the top N levels of classifications of the first webpage link and the second webpage link, based on the highest number of same classification from the first webpage link and the second webpage link, name the folder.

18. The system according to claim 17, wherein the matching unit is further configured to:
when there is no same classification among the top N levels of classifications of the first webpage link and the second webpage link, name the folder based on the preset folder name.

19. The system according to claim 11, wherein:
the receiving unit is further configured to receive a signal that a user holds and drags any other webpage link address displayed on the browser to the position of the folder; and
the storage unit is further configured to store the webpage link address that is held and dragged by the user in the folder.

20. The system according to claim 11, wherein:
the webpage link is one of a webpage link in a bookmark of the browser, a webpage link in browsing history, a webpage link in favorites, and a webpage link corresponding to a quick link of the browser.
